(19) United States
(12) Patent Application Publication
(10) Pub. No.: US 2026/0081838 A1
(43) Pub. Date: Mar. 19, 2026

(54) Automatic Configuration of a Network Device Provisioning and Onboarding Service

(71) Applicant: Arista Networks, Inc., Santa Clara, CA (US)

(72) Inventors: Matthew E. Hartzel, Durham, NC (US); Cheyne Womble, Mebane, NC (US); Clay Hoy, Louisburg, KS (US)

(21) Appl. No.: 18/890,499

(22) Filed: Sep. 19, 2024

(51) Int. Cl. H04L 41/0895; H04L 41/0806; H04L 41/12

(52) U.S. Cl. CPC H04L 41/0895; H04L 41/0806; H04L 41/12

(57) ABSTRACT

Topology management equipment may implement a virtual topology using network node instances configured on host equipment. The topology management equipment may configure a device management server instance and a network device instance to automatically perform a network device self-provisioning operation, including a network address assignment operation for the network device instance, and a network device onboarding operation.

### BACKGROUND

A communication network can include network nodes that are interconnected such that network traffic is conveyed from source devices to destination devices through the network. In some scenarios, a system can simulate the network nodes and their interconnectivity to virtualize the network for validation, testing, and/or other purposes.

### BRIEF DESCRIPTION OF THE DRAWINGS

FIG. 1 is a diagram of an illustrative networking system implementing a virtual topology in accordance with some embodiments.

FIG. 2 is a diagram of illustrative topology management equipment that provides instructions to instantiate and configure network node instances based on received topology information in accordance with some embodiments.

FIG. 3 is a diagram of illustrative topology management equipment that provides a management network implemented as part of the virtual topology in accordance with some embodiments.

FIG. 4 is a diagram of illustrative topology management equipment that configures a network device to boot up in a provisioning mode in accordance with some embodiments.

FIG. 5 is a diagram of illustrative topology management equipment that configures a device management server to provide a network address assignment service in accordance with some embodiments.

FIG. 6 is a diagram of illustrative communications between the configured network device and the configured device management server in accordance with some embodiments.

FIG. 7 is a flowchart of illustrative operations for configuring a virtual topology to perform network device provisioning and onboarding in accordance with some embodiments.

### DETAILED DESCRIPTION

A network can include network devices for conveying network traffic, e.g., in the form of frames, packets, etc., between devices in the network. Actual deployment and configuration of these network nodes for a physical network can be resource-intensive (e.g., cost-intensive, labor-intensive, time-consuming, etc.) and/or can be error-prone. Accordingly, it may be desirable to simulate a production network or other types of physically deployed (or to-be-deployed) networks in a virtual environment to perform validation, to perform testing, and/or for other purposes. To this end, a virtual topology containing virtual instances of network nodes that simulate the actual topology of the network nodes in the physical network may be provided using host equipment (e.g., one or more hosts). The simulated topology and therefore the virtual topology can include numerous network nodes (e.g., hundreds of network devices, thousands of network devices, etc.). It may be tedious for a user (e.g., a network administrator) to manually configure (e.g., provision) each of the network device instances in the virtual topology and to onboard each of the network device instances to a device management server (e.g., a device management server instance in the virtual topology).

In illustrative configurations sometimes described herein as an example, virtual topology management equipment may receive a topology file and may provide instructions to instantiate and configure connectivity between a device management server instance and a network device instance in the virtual topology based on the topology file. The topology management equipment may configure (e.g., by sending an instruction to the host or host management equipment) the network device instance to boot up in a provisioning mode (in which the network device initiates a device self-provisioning operation, starting with network address assignment) based on corresponding indications in the topology file. The topology management equipment may configure (e.g., by sending an instruction to the host or host management equipment) the device management server instance to provide a network address assignment service based on a configuration file generated by the topology management equipment. Configured in this manner, the network device instance may automatically (e.g., upon bootup in the provisioning mode) perform the self-provisioning operation (including the network address assignment operation) using the device management server instance. The device management server instance may automatically (e.g., when participating in the provisioning operation of the network device instance) onboard the network device instance such that the network device instance is accessible (e.g., viewable, manageable, etc.) via the device management server instance.

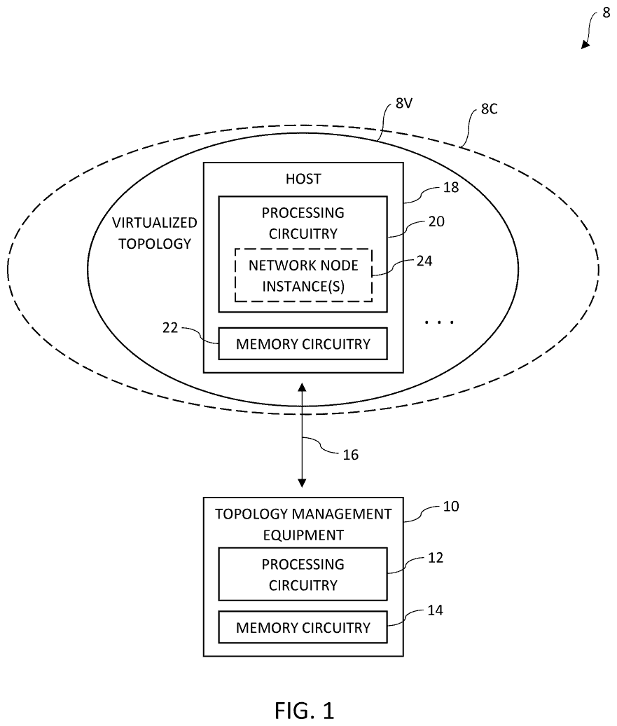

By configuring any suitable number of network device instances in the virtual topology and, if desired, any additional device management server instance(s) in an analogous manner, network device instances can be provisioned and onboarded at scale by device management server instance(s), thereby reducing the need for manual user intervention for provisioning and onboarding of network devices. An illustrative networking system in which a virtual topology containing network node instances is managed by virtual topology management equipment (e.g., in the manner described above) is shown in FIG. 1. In the example of FIG. 1, the networking system may include one or more components of a network such as network 8. Network 8 may have any suitable scope. As examples, network 8 may include, be, and/or form part of one or more local segments, one or more local area networks (LANs), one or more virtual LANs (VLANs), one or more subnets, one or more datacenter networks, one or more campus area networks, one or more metropolitan area networks, a wide area network, etc. Network 8 may include a wired network (portion) based on wired technologies or standards such as Ethernet (e.g., using copper cables and/or fiber optic cables) and a wireless network (portion) such as one or more wireless local area networks (WLANs) (e.g., wireless networks compliant with the IEEE 802.11 standard(s)). If desired, network 8 may include internet service provider networks (e.g., the Internet) or other public service provider networks, private service provider networks (e.g., multiprotocol label switching (MPLS) networks), and/or other types of networks such as telecommunication service provider networks.

Network 8 may include, e.g., as an end host, topology management equipment 10. To simulate a network topology, topology management equipment 10 may be communicatively coupled to components of a network (portion) 8V configurable by topology management equipment 10 to form a virtual network topology (e.g., simulating a physically (to-be-)deployed network topology). Accordingly, equipment 10 may sometimes be referred to as virtual topology management equipment 10 or network topology virtualization equipment 10. To implement the functions of equipment 10, equipment 10 may include processing circuitry 12 and memory circuitry 14, among other components (e.g., input-output interfaces such as network interfaces that provide connectivity to other components of network 8, power supply and management circuitry that provides power to components of equipment 10, etc.).

In some illustrative configurations sometimes described herein as an example, topology management equipment 10 may be implemented on server equipment, e.g., as a virtual topology management server providing a virtual topology management service. The server equipment on which equipment 10 is implemented may include server hardware such as one or more blade servers, one or more rack servers, and/or one or more tower servers. Processing circuitry 12 and memory circuitry 14 for implementing the functions of equipment 10 may be provided as compute devices and storage devices of the server hardware.

Processing circuitry 12 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Memory circuitry 14 may include non-volatile memory (e.g., one or more of flash memories, electrically-programmable read-only memories, solid-state drives, hard disk drives, etc.), volatile memory (e.g., static and/or dynamic random-access memories), removable storage devices (e.g., storage devices removably coupled to equipment 10), and/or other types of memory circuitry. In general, memory circuitry 14 may include one or more non-transitory (tangible) computer-readable storage media that store the operating system software and/or any other software code, sometimes referred to as program instructions, software, data, instructions, or code. Processing circuitry 12 may run (e.g., execute) an operating system and/or other software and firmware stored on the one or more non-transitory computer-readable storage media to perform the operations of topology management equipment 10 described herein.

In other illustrative arrangements, topology management equipment 10 (e.g., processing circuitry 12 and memory circuitry 14) may be implemented on one or more dedicated local host devices or generally implemented using non-server hardware, in instead of or in addition to the provided topology management server described above.

Equipment 10 may manage, based on processing circuitry 12 executing software instructions stored on memory circuitry 14, the creation, maintenance, update, and/or deletion of one or more topologies (e.g., a virtual topology having network nodes implemented as virtual machine instances on host equipment). In the example of FIG. 1, equipment 10 may be communicatively coupled, via one or more communication paths 16, to one or more hosts such as multiple instances of host 18 (one or more of which is sometimes referred to herein as host equipment). In particular, equipment 10 may exchange messages with host(s) 18 (e.g., send configuration instructions to host(s) 18, receive messages containing host information from host(s) 18, etc.).

These messages may be exchanged via any suitable types of communication paths 16. These communication paths between equipment 10 and host(s) 18 may include wired network paths through a wired network (e.g., network devices therein) in network 8, through the Internet, etc. If desired, one or more of host(s) 18 may be directly connected (e.g., wired) to equipment 10 without other intervening network devices. If desired, equipment 10 may configure (e.g., send configuration instructions to) or otherwise communicate with host(s) 18 (e.g., network nodes instances thereon) through intervening host management equipment (e.g., virtual machine management equipment that assists in the management of virtual machine instances on host(s) 18, network management equipment that manages the local network portion(s) to which host(s) 18 is attached, etc.).

As shown in FIG. 1, by configuring host(s) 18 (e.g., network node instances thereon and the interconnection therebetween), equipment 10 may implement virtual topology 8V in network 8. In other words, the manner in which host(s) 18 are configured to form network node instances and/or to form communicatively coupling selectively between the network node instances implemented on hosts(s) 18 may provide virtual topology 8V (e.g., that simulates a physical topology in which the analogously configured network nodes are physically deployed).

In illustrative configurations sometimes described herein as an example, virtual topology 8V may be provided within a cloud network (e.g., a datacenter network that provides cloud services) such as cloud network 8C. Cloud network 8C may be a virtual private cloud network formed from a (tenant) portion of a public (shared) cloud network, may be a private cloud network (e.g., formed from on-premise infrastructure), or may be formed from a combination of private cloud and public cloud networks (e.g., a hybrid public-private cloud network).

Accordingly, instances of host 18 may be provided as end hosts in cloud network 8C. These hosts 18 may be interconnected by network infrastructure hardware, such as switches, routers, gateways, etc., in cloud network 8C.

In some illustrative configurations described herein as an example, one or more hosts 18 may be implemented on server equipment, e.g., to provide compute, storage, and/or management resources (e.g., compute, storage, and/or management services). To provide these resources, host equipment 18 may include processing circuitry 20 and memory circuitry 22, among other components (e.g., input-output interfaces such as network interfaces that provide connectivity to other components of network 8, power supply and management circuitry that provides power to components of host equipment 18, etc.). The server equipment based on which host equipment 18 is implemented may include server hardware such as one or more blade servers, one or more rack servers, and/or one or more tower servers. Processing circuitry 20 and memory circuitry 22 may be provided as compute devices and storage devices of the server hardware.

Processing circuitry 20 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Memory circuitry 22 may include non-volatile memory (e.g., one or more of flash memories, electrically-programmable read-only memories, solid-state drives, hard disk drives, etc.), volatile memory (e.g., static and/or dynamic random-access memories), removable storage devices (e.g., storage devices removably coupled to host equipment 18), and/or other types of memory circuitry. In general, memory circuitry 22 may include one or more non-transitory (tangible) computer-readable storage media that store the operating system software and/or any other software code, sometimes referred to as program instructions, software, data, instructions, or code. Processing circuitry 20 may run (e.g., execute) an operating system and/or other software and firmware stored on the one or more non-transitory computer-readable storage media to perform the operations of host equipment 18 described herein.

If desired, in other illustrative configurations, virtual topology 8V may be hosted on other types of host equipment (e.g., non-server equipment) that are part of other types of networks (e.g., a non-cloud network, a non-datacenter network, etc.). If desired, one or more (e.g., at least some, all, etc.) of the network nodes forming part of the topology managed by equipment 10 may be implemented on corresponding network node hardware (e.g., as switches, routers, etc., formed on network infrastructure hardware instead of as virtual machine instances executing on host equipment 18).

Virtual topology management equipment 10 may provide software (e.g., as part of configuration instructions) for storage on memory circuitry 22 of hosts 18 and for execution by processing circuitry 20 of hosts 18 to form one or more network node instances 24 on each host 18 for virtual topology 8V. As an example, network node instances 24 may include network device instances (sometimes referred to as virtual network devices or simply as network devices). Instances of these network devices in virtual topology 8V may include network switches (e.g., multi-layer (Layer 2 and Layer 3) switches, single-layer (Layer 2) switches, etc.), bridges, routers, gateways, hubs, repeaters, firewalls, devices serving other networking functions, controllers devices that control the operation of other network device(s), or devices that include the functionality of two or more of the aforementioned types of network devices. To implement one or more of these network device instances, equipment 10 may provide, to the corresponding host 18 as part of configuration instructions, network device operating system software, configuration data (e.g., a start-up configuration, in some scenarios), and/or other information that facilitates the control plane operations of the network device instance. In such a manner, processing circuitry 20 may instantiate a virtual machine instance executing the network device software stored on memory circuitry 22, as provided by equipment 10.

As just a few examples, processing circuitry 20 may execute, as part of the network device instance, network device control plane software such as network device operating system software, routing policy management software, routing protocol agents or processes, routing information base agents, and other network device control software, may be used to support the operation of protocol clients and/or servers (e.g., to form some or all of a communications protocol stack), may store and/or process packet forwarding decision data, may execute packet processing software, and/or may execute other software instructions that implement the functions of the network device instance.

Network node instances 24 formed on a given host 18 (e.g., the same host 18 as or a different host 18 than the one executing at least one network device instance) may also include server instances (sometimes referred to herein simply as servers). In illustrative configurations described herein as an example, a network node instance 24 may be a device management server instance (sometimes referred herein to generally as a management node instance). To implement the device management server instance or other server instances, equipment 10 may provide, to the corresponding host 18 as part of configuration instructions, server operating system software, configuration data, and/or other information that facilitates the performance of services and/or applications by the server instance(s). In such a manner, processing circuitry 20 may instantiate a virtual machine instance executing the server software stored on memory circuitry 22, as provided by equipment 10.

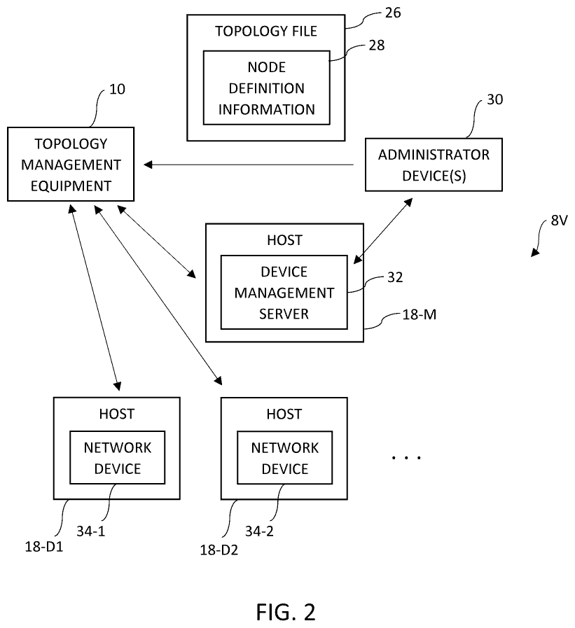

Topology management equipment 10 may form virtual topology 8V based on topology information defining virtual topology 8V obtained by equipment 10. In other words, based on the topology information, equipment 10 may configure or otherwise control, by providing instructions and/or configuration data to, hosts 18 to form virtual topology 8V. FIG. 2 is a diagram of illustrative topology management equipment such as equipment 10 (FIG. 1) that communicates with host equipment to form a virtual topology in accordance with received topology information.

As shown in FIG. 2, topology management equipment 10 (e.g., processing circuitry 12 thereof) may receive or otherwise obtain topology information in the form of a topology file such as topology file 26. In some illustrative configurations described herein as an example, an administrator device such as device 30 (e.g., a computing device such as a laptop, desktop, etc.) may provide topology file 26 to equipment 10. If desired, equipment 10 (e.g., processing circuitry 12 thereof) may obtain topology information in other manners (e.g., as a set of user inputs through a user interface, as a set of commands, in multiple topology files, etc.) and/or from other sources.

The obtained topology information (e.g., topology file 26) may include node definition information 28 for each network node to be virtualized in virtual topology 8V (e.g., instantiated on host equipment 18) and corresponding configuration data (e.g., parameters) for each network node. As just a few examples, node definition information 28 may specify, for each network node instance, the type of network node (e.g., a switch, a type of switch such as a leaf switch, a spine switch, a core switch, etc., a router, a gateway, a device management server, another type of server, etc.), one or more network addresses to be assigned to the network node (e.g., an Internet Protocol (IP) address such as a private management IP address), number and type(s) of (virtual) input-output interfaces (e.g., Ethernet interfaces) to be formed for the network node, functionalities to be enabled or disabled for the network node (e.g., enable boot up of a network device in a provisioning mode, enable network address assignment service on a management server, enable one or more protocols on the network node, etc.), etc.

In the example of FIG. 2, topology management equipment 10 (e.g., processing circuitry 12 when executing software instructions stored on memory circuitry 14) may configure a virtual topology with network node instances 24 (FIG. 1) based on topology file 26 by providing messages containing instructions, configuration data, and/or other information to host(s) 18 (e.g., network device operating system software, server operating system software, other software, virtual interfaces to be formed, other configuration parameters, etc.). In particular, based on node definition information 28, equipment 10 (e.g., processing circuitry 12) may configure, at least in part by transmitting corresponding operating system software to, respective host equipment 18 to instantiate a first network device 34-1 on host 18-D1 (e.g., a first instance of host 18 in FIG. 1), a second network device 34-2 on host 18-D2 (e.g., a second instance of host 18 in FIG. 1), and a device management server 32 on host 18-M (e.g., a third instance of host 18 in FIG. 1) to form virtual topology 8V. In general, any suitable number of network devices 34 may be instantiated to form virtual topology 8V. Device management server 32 may sometimes be referred to as a device management server instance 32 or more generally as a device management node 32.

As the number of network devices 34 to be implemented in virtual topology 8V grows, it can be especially time-consuming and error-prone to manually configure each of the network devices 34 for operation (or even to manually specify different configurations for different types of network devices). Additionally, device management server 32 may provide a device management platform through which network devices 34 in virtual topology 8V can be accessed. As examples, an administrator device, such as device 30, may access the device management platform (e.g., through an Internet connection) to view information of network devices 34 in virtual topology 8V, to configure (e.g., update the configuration of) network devices in virtual topology 8V, to generally manage network devices in virtual topology 8V, etc. To facilitate access to these network devices 34, device management server 32 may have to first onboard (e.g., register, store information for, receive update messages from, etc.) these network devices 34. However, this device onboarding operation also often requires manual user input, which can be time consuming and error-prone, especially if the number of network devices 34 to be implemented in virtual topology 8V is large (e.g., in the hundreds or thousands of network devices 34).

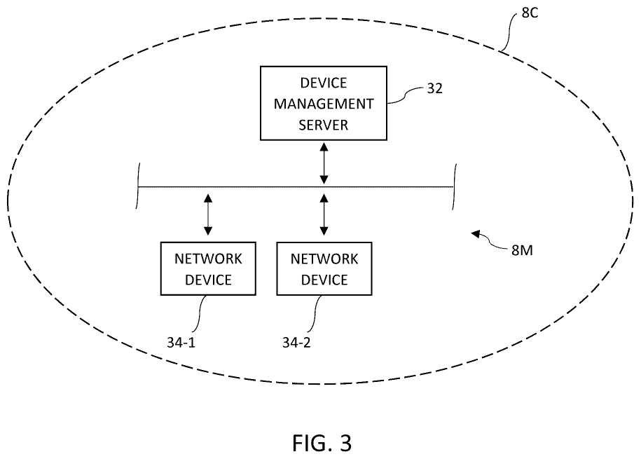

To simplify and generally improve the provisioning and onboarding of network devices, topology management equipment such as equipment 10 (e.g., processing circuitry 12 when executing software instruction on memory circuitry 14) may configure virtual topology 8V (e.g., hosts 18 therein) to facilitate provisioning of network devices using the management server to provide the network address assignment service and, subsequently, the bootstrap data, thereby facilitating the automatic onboarding of the network devices by the device management server based on the provisioning of the network devices. FIGS. 3-5 illustrates different manners in which topology management equipment 10 (e.g., processing circuitry 12 executing software instructions on memory circuitry 14) may configure virtual topology 8V (e.g., hosts 18 therein) to perform these operations (e.g., the provisioning and onboarding of network devices using the device management server).

FIG. 3 is a diagram of illustrative topology management equipment such as equipment 10 (FIGS. 1 and 2) that configures a management network as part of virtual topology 8V (FIGS. 1 and 2), e.g., by processing circuitry 12 (FIG. 1) transmitting network interface and/or connectivity configuration information to hosts 18. In particular, a management network such as network 8M for virtual topology 8V may be implemented as an overlay network (e.g., using overlay technology such as tunneling) on top of an underlay network such as cloud network 8C (e.g., the underlay network infrastructure hardware of network 8C may forward traffic for the overlay network, without necessarily participating the overlay network and the services provided by the overlay network). In illustrative configurations described herein as an example, cloud network 8C may be a network layer (L3) network that includes L3 network devices configured to provide a subnet in which traffic for virtual topology 8V and other traffic for other hosts are handled (e.g., routed, forwarded, processed, etc.). Management network 8M may be implemented as a data link layer (Layer 2) overlay network, using the underlay network infrastructure hardware for transport of the messages between the network nodes of management network 8M.

Accordingly, after and/or as part of instantiation of each of the network node instances (as described in connection with FIG. 2), processing circuitry 12 of topology management equipment 10 may configure hosts 18 (e.g., by providing instructions and/or configuration data to hosts 18) to implement host equipment processing that provides the L2 overlay service, thereby forming the management connections of network 8M between the different virtual network node instances. In the example of FIG. 3, processing circuitry 12 of equipment 10 may provide instructions and/or configuration data to host equipment 18 to form management communication paths between device management server 32, network device 34-1, and network device 34-2 implemented on the host equipment 18 to form network 8M.

In particular, processing circuitry 12 (FIG. 1) of equipment 10 may configure host(s) 18 for network node instances (e.g., by sending instructions and/or configuration data to these hosts) to form virtual management interfaces (e.g., management ports) thereon for communicatively coupling each network device instance 34 to at least device management server instance 32. Additionally, processing circuitry 12 of equipment 10 may configure device management server 32 (e.g., by sending corresponding instructions and/or configuration data to host 18-M in FIG. 2) to serve as the bridge device for management network 8M such that server 32 is reachable by each of network devices 34-1, 34-2, and any other network devices in management network 8M.

Management (e.g., control) messages between different nodes of virtual topology 8V may be conveyed using management network 8M (e.g., a management topology), whereas other traffic (e.g., simulated data plane traffic) between different nodes of virtual topology 8V may be conveyed using a different data plane topology (e.g., a leaf-spine architecture including uplinks, downlinks, link aggregation groups, etc.). Both of these topologies (e.g., the management topology and the data plane topology) may be implemented as overlay services (e.g., a virtual extensible local area network (VXLAN) service) on top of the underlay infrastructure of cloud network 8C (e.g., using the network infrastructure hardware of network 8C for transport).

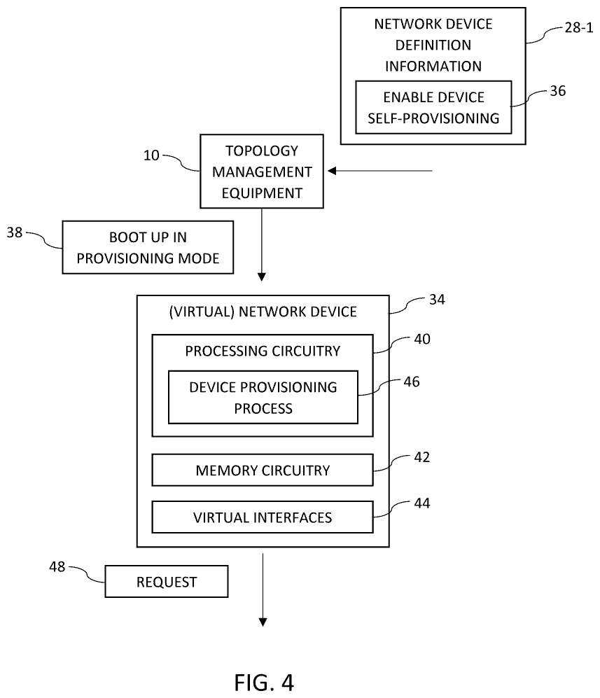

Topology management equipment 10 (e.g., processing circuitry 12 executing corresponding software instructions on memory circuitry 14) may further configure the instantiated network devices 34-1, 34-2, etc. in FIG. 2 (e.g., by sending instructions and/or configuration data to the corresponding host(s) 18-D1, 18-D2, etc.) to facilitate the performance of device self-provisioning operations (e.g., zero-touch provisioning operations) by these network devices. FIG. 4 is a diagram of illustrative topology management equipment such as equipment 10 (FIGS. 1-3) that configures a given network device 34 (e.g., one of network device 34-1, network device 34-2, or another network device in virtual topology 8V) to perform network device provisioning using a device management server instance (e.g., server 32 in FIG. 2) in the same virtual topology 8V.

In the example of FIG. 4, processing circuitry 12 (FIG. 1) of topology management equipment 10 may obtain network device definition information 28-1 (e.g., an instance of node definition information 28 in topology file 26 in FIG. 2) for defining the configuration of a given network device 34 in virtual topology 8V. In particular, information 28-1 may include, among other things as described in connection with information 28 in FIG. 2, an indication 36 to enable network device self-provisioning for the given network device 34. As examples, indication 36 may be a flag that is set, a parameter that has a particular value, etc., within the definition information 28-1 for the given network device 34. In response to receiving network device definition information 28-1 and based on indication 36, processing circuitry 12 of equipment 10 may generate and transmit, to the given network device 34, a corresponding indication 38 (e.g., an instruction, a command, as part of configuration data, etc.) for network device 34 to boot up in a provisioning mode of operation.

As shown in FIG. 4, the given (virtual) network device 34 may include associated processing circuitry 40 (e.g., the portion of host processing circuitry 20 in FIG. 1 on which the virtual network device instance 34 is executed and/or compute resources of host processing circuitry 20 allocated to the virtual network device instance 34), associated memory circuitry 42 (e.g., the portion of host memory circuitry 22 in FIG. 1 in which software for the virtual network device instance 34 is stored and with which processing circuitry 40 operates, and/or storage resources of host memory circuitry 20 allocated to the virtual network device instance 34), and associated virtual interfaces 44 such as virtual management interfaces coupled to management network 8M (FIG. 3) and virtual data plane interfaces coupled to a data plane topology of virtual topology 8V. These virtual interfaces may be implemented using host network interface circuitry on host 18, and network interfaces formed therefrom may be allocated for use by the virtual network device instance 34.

After the network device 34 boots up, based on receiving and processing (e.g., being configured by) indication 38, processing circuitry 40 (e.g., a portion of host processing circuitry 20 in FIG. 1) may execute a device provisioning process 46 based on corresponding software instructions stored on memory circuitry 42 (e.g., a portion of host memory circuitry 22 in FIG. 1). In particular, when the network device 34 boots up, the network device 34 may be an un-provisioned network device (e.g., a network device that is not fully provisioned, is not yet ready to perform networking functions within topology 8V, lacks a startup configuration, and/or lacks a network address with which to configure at least some virtual interface(s) 44). By executing process 46, processing circuitry 40 may be configured to perform a device self-provisioning operation which, if successful, results in circuitry 40 obtaining information (e.g., bootstrap data such as a bootstrap script for execution by processing circuitry 40) for fully provisioning the network device 34.

In one illustrative configuration sometimes described herein as an example, processing circuitry 40, when executing process 46, may first perform a network address assignment operation as part of the device self-provisioning operation. In particular, processing circuitry 40, as part of performing the network address assignment operation, may generate and transmit a request such as request 48 for requesting a network address for configuring a virtual management interface of network device 34 coupled to management network 8M and through which the bootstrap data for network device 34 can later be obtained. The sending of request 48 may be the first of multiple operations performed by processing circuitry 40 to fully provision network device 34 itself. Accordingly, these operations may sometimes be referred to collectively as a network device (self-)provisioning operation.

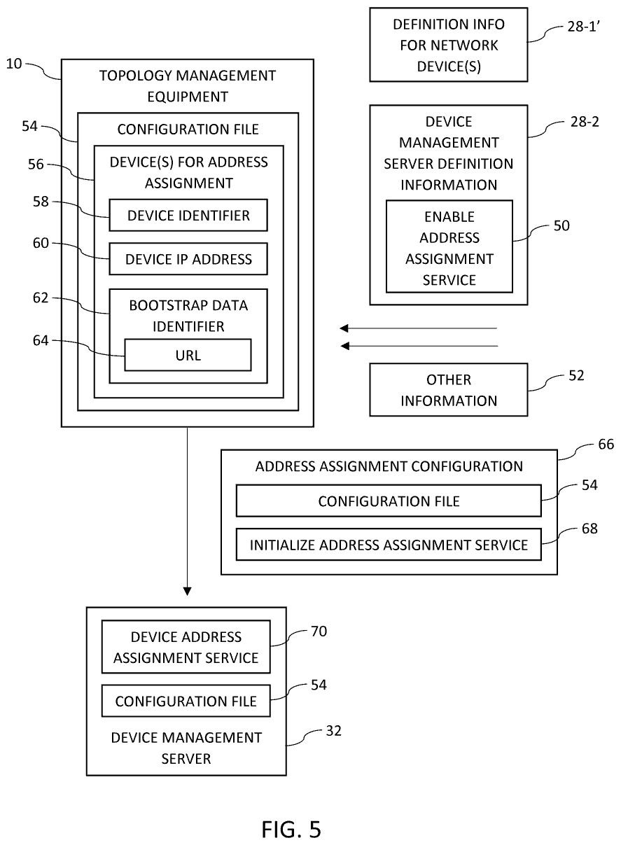

Management equipment 10 (e.g., processing circuitry 12 executing corresponding software instructions on memory circuitry 14) may further configure the instantiated device management server instance 32 in FIG. 2 (e.g., by sending instructions and/or configuration data to the corresponding host 18-M) to participate in (e.g., facilitate) the self-provisioning operations of network devices 34 (e.g., by providing an address assignment service thereon, by providing the bootstrap data for network devices 34, etc.). FIG. 5 is a diagram of illustrative topology management equipment such as equipment 10 (FIGS. 1-4) that configures a device management server 32 to participate in the self-provisioning operations of network devices 34 in the same virtual topology 8V.

In the example of FIG. 5, processing circuitry 12 (FIG. 1) of topology management equipment 10 may obtain device management server definition information 28-2 (e.g., an instance of node definition information 28 in topology file 26 in FIG. 2) for defining the configuration of a given device management server instance 32 in virtual topology 8V. In particular, information 28-2 may include, among other things as described in connection with information 28 in FIG. 2, an indication 50 to enable a network address (e.g., IP address) assignment service on (e.g., at) the device management server instance 32. As examples, indication 50 may be a flag that is set, a parameter that has a particular value, etc., within the definition information 28-2 for the given device management server 32. Configurations in which the network address assignment service is a Dynamic Host Configuration Protocol (DHCP) service (e.g., a DHCPv4 service and/or a DHCPv6 service) are sometimes described herein as an example. In response to receiving device management server definition information 28-2 and based on indication 50, processing circuitry 12 of equipment 10 may generate a configuration file such as network address assignment configuration file 54 usable by the network address assignment service at device management server 32 to provide the desired network address assignment behavior and/or network device provisioning behavior.

As shown in FIG. 5, processing circuitry 12 of equipment 10 may generate (e.g., populate) configuration file 54 with information for each of devices 56 for which the network address assignment service should be provided. Devices 56 may include network device instances 34 (e.g., instances of network device 34 in FIGS. 2 and 4). If desired, device 56 may include other devices specified in topology file 26 (FIG. 2).

For each device 56, configuration file 54 may include a device identifier 58 (e.g., a media access control (MAC) address, a serial number, a virtual instance identifier, another type of unique device identifier, etc., identifying or otherwise associated with the (virtual) device and/or the hardware on which the (virtual) device is implemented), a device IP address 60 to be assigned (e.g., a static IP address, or if desired, a later-selected dynamic IP address from a pool of assignable IP addresses), and a bootstrap data identifier 62 (e.g., identifying a name and/or location of bootstrap data). In illustrative configurations sometimes described herein as an example, identifier 62 may be or include a uniform resource locator (URL) 64 usable by a device to locate the bootstrap data.

Processing circuitry 12 (FIG. 1) of equipment 10 may obtain the information with which configuration file 54 is populated in different ways and/or from different sources. In some illustrative configurations sometimes described herein as an example, device identifier 58 for each of network devices 34 may be absent from configuration file 26. Accordingly, processing circuitry 12 of equipment 10 may obtain device identifier 58 for each of network devices 34 during and/or after the instantiation of the corresponding network device 34 on the respective host 18 for that network device 34, e.g., as described in connection with FIG. 2. In some instances, device identifier 58 may be a hardware address (e.g., a MAC address of host 18 or a MAC address of a component of host 18) obtained from host 18 during and/or after the network device instance 34 has been instantiated on the host 18.

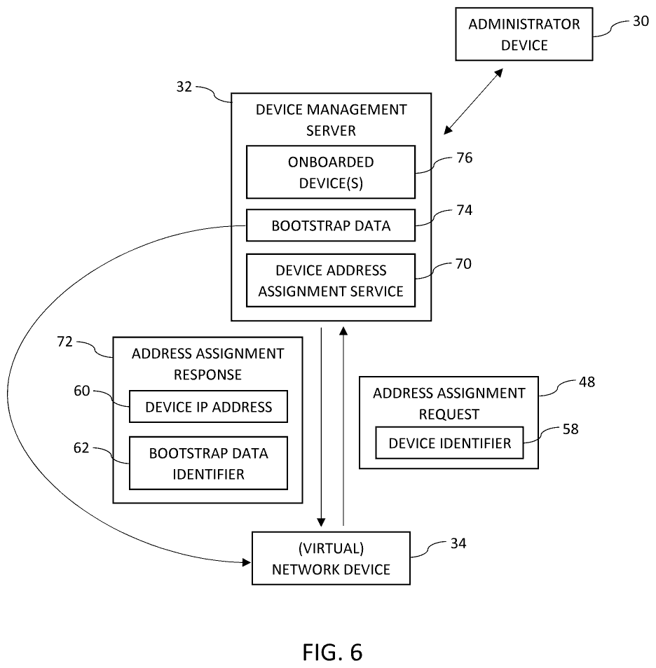

If desired, processing circuitry 12 of equipment 10 may generate device identifier 58 (e.g., a unique device identifier) and may provide the generated device identifier to the corresponding identified network device instance 34, during and/or after the instantiation of the network device 34, for storage. The identified network address instance 34 may be configured to perform the network address assignment operation using this generated identifier to identify itself (e.g., may include this generated identifier in request 48 in FIGS. 4 and 6). The same generated device identifier 58 may be used to populate configuration file 54 for the corresponding identified network device 34.

In some illustrative configurations sometimes described herein as an example, processing circuitry 12 of equipment 10 may obtain a device IP address 60 (or a set of assignable IP addresses) based on information in topology file 26 (FIG. 2). More specifically, processing circuitry 12 of equipment 10 may receive, as part of topology file 26, definition information 28-1′ for network device(s) (e.g., including definition information 28-1 in FIG. 4 and definition information for other network devices in virtual topology 8V) and, if desired, definition information for other types of devices in the same virtual topology 8V that desire network addresses to be assigned.

In some illustrative configurations sometimes described herein as an example, processing circuitry 12 of equipment 10 may obtain a URL 64 for bootstrap data or other types of identifier 62 for identifying the name and/or location of bootstrap data, from topology file 26 (FIG. 2). If desired, URL 64 or other types of identifiers 62 (e.g., identifying one or more default sources of bootstrap data) may be maintained (e.g., stored) on memory circuitry 14 (FIG. 1) of equipment 10, and processing circuitry 12 may populate configuration file 54 using the stored bootstrap data identifier 62. If desired, processing circuitry 12 of equipment 10 may obtain bootstrap data identifier 62 as part of other information from the administrator device 30 (FIG. 2) or from another source. As desired, (at least some) devices 56 (e.g., network devices 34) may be associated with the same bootstrap data identifier 62 and/or (at least some) devices 56 (e.g., network devices 34) may be associated with different bootstrap data identifiers 62 (e.g., to receive different bootstrap data).

After generating configuration file 54, processing circuitry 12 of equipment 10 may provide (e.g., transmit) configuration file 54 as part of address assignment configuration information 66 to device management server 32. Processing circuitry 12 of equipment 10 may also provide an indication 68 to initialize a network address assignment service along with configuration file 54 in address assignment configuration information 66. Upon receiving information 66, device management server 32 (e.g., a portion of processing circuitry 20 of host 18-M in FIG. 2) may store configuration file 54 on memory circuitry 22 of host 18-M (FIG. 2) and may execute corresponding software instructions stored on memory circuitry 22 of host 18-M to execute network address assignment service 70 (e.g., a server-side DHCP application).

Processing circuitry 20 of host 18-M for implementing device management server 32 may perform the operations of service 70 using configuration file 54.

FIG. 6 is a diagram of illustrative communications between a network device instance 34 (e.g., configured by processing circuitry 12 of equipment 10 in the manner described in connection with FIG. 4) and a device management server instance 32 (e.g., configured by processing circuitry of equipment 10 in the manner described in connection with FIG. 5). As shown in the example of FIG. 6, network device 34 (e.g., processing circuitry 40 in FIG. 4 when executing process 46) may, upon booting up into a (self-)provisioning mode, generate and transmit (e.g., broadcast on management network 8M in FIG. 3) a network address assignment request 48 (e.g., a DHCP request message). Request 48 may include the device identifier 58 for the transmitting network device 34.

Based on receiving network address assignment request 48, device management server 32 (e.g., processing circuitry 20 of host 18-M in FIG. 2, executing service 70) may determine, based on identifier 58 in request 48, the (static or dynamic) corresponding IP address to be assigned to the device with the received device identifier 58. Management server 32 (e.g., processing circuitry 20 of host 18-M) may also determine, based on identifier 58 in request 48, the corresponding bootstrap data identifier 62 identifying the bootstrap data to be used in provisioning the network device.

In particular, device management server 32 (e.g., processing circuitry 20 of host 18-M, executing service 70) may perform a lookup operation in configuration file 54 to identify the matching device 56 (FIG. 5) having the same device identifier as that received in request 48 and may use the IP address 60 and the bootstrap data identifier 62 of the matching device 56 as the determined IP address and bootstrap data identifier, respectively. Accordingly, management server 32 (e.g., processing circuitry 20 on host 18-M, executing service 70) may generate and transmit, to network device 34, a network address assignment response 72 (e.g., a DHCP response message) containing the determined (assigned) IP address 60 and the determined bootstrap data identifier 62 (e.g., URL 64).

Based on receiving network address assignment response 72, processing circuitry 40 (FIG. 4) of network device 34 may configure a virtual interface 44 (e.g., a management interface coupled to management network 8M in FIG. 3) based on the received IP address 60 in response 72. Processing circuitry 40 of network device 34 may further obtain bootstrap data based on the received bootstrap data identifier 62 in response 72.

In some illustrative configurations described sometimes herein as an example, identifier 62 may identify a location on device management server 32 (e.g., reachable using URL 64 received in response 72 by network device 34) that stores bootstrap data (e.g., bootstrap data 74) for network device 34. Accordingly, processing circuitry 40 of network device 34 may access bootstrap data 74 via its management interface using identifier 62 (e.g., URL 64). Thereafter, processing circuitry 40 of network device 34, when executing process 46, may provision itself based on processing bootstrap data 74 (e.g., executing script(s) in bootstrap data 74, storing configuration data in bootstrap data 74, etc.).

Device management server 32 may provide a device management platform through which devices such as administrator device 30 can access (onboarded or registered) network device instances in virtual topology 8V, e.g., to obtain state information of network device instances, to receive other types of output regarding network device instances, to update the configuration of network device instances, to provide other types of input to network device instances, etc. In particular, processing circuitry 12 (FIG. 1) of equipment 10 may provide software and configuration data to host 18-M (FIG. 2) to configure server 32 to provide the device management platform that serves and an interface between server 32 and external equipment (e.g., external to virtual topology 8V) such as administrator device 30.

Because device management server 32 facilitates the provisioning operation of the network device instances by serving as the address assignment server (and the source of the bootstrap data), device management server 32 may automatically (e.g., without further user intervention) learn of the presence of network device instances 34 in virtual topology 8V, as the network device instances are configured to perform device self-provisioning operations upon boot up in the provisioning mode. Accordingly, when device management server 32 (e.g., processing circuitry 20 of host 18-M in FIG. 2) identifies a given network device instance 34 (e.g., based on receiving request 48 containing device identifier 58 for the given network device instances 34), device management server 32 may automatically (e.g., without further user intervention) onboard (e.g., register) network device 34 internally.

As an example, device management server 32 (e.g., processing circuitry 20 of host 18-M in FIG. 2) may store, as part of the onboarding process, information of the identified network device instance 34 as onboarded device information, may identify the network device instance 34 as an onboarded device 76 (amongst a list of onboarded network devices in virtual topology 8V), may otherwise track the provisioning progress of the network device instance 34 (e.g., whether device 34 is fully provisioned), etc. In general, device management server 32 (e.g., processing circuitry 20 of host 18-M in FIG. 2) may store any suitable information of onboarded network devices on memory circuitry 22 of host 18-M. A device such as administrator device 30 may thereby access onboarded devices 76 and information thereof via server 32 (e.g., to view onboarded device information, to configure or update the configuration of onboarded devices, etc.).

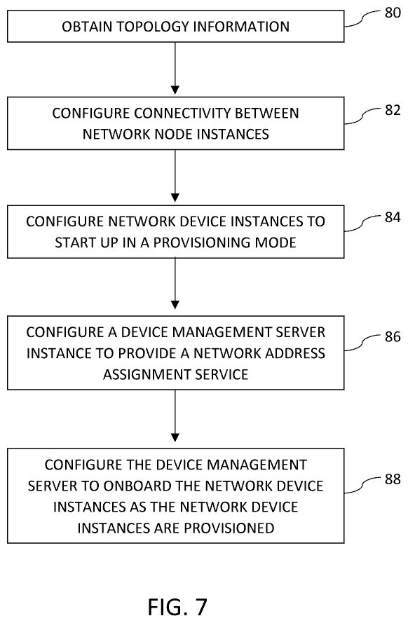

FIG. 7 is a flowchart of illustrative operations for provisioning and onboarding network devices. In particular, these operations may be performed by processing circuitry 12 of topology management equipment 10 (FIG. 1) using other components of equipment 10 (e.g., memory circuitry 14, network interfaces thereon, etc.). In configurations described herein as an illustrative example, the operations described in connection with FIG. 7 may be performed by processing circuitry 12 executing software instructions stored on memory circuitry 14. If desired, one or more operations described in connection with FIG. 7 may be performed by other (dedicated) hardware components in equipment 10. If desired, processing circuitry and memory circuitry of other types of devices may similarly be configured to perform the operations described in connection with FIG. 7.

At block 80, processing circuitry (e.g., of virtual topology management equipment) may obtain topology information. As an example, the processing circuitry may perform at least some (e.g., all) of the operations described in connection with FIGS. 2, 4, and 5 at block 80. In particular, the obtained topology information may include definition information for the various network node instances (e.g., network device instances, device management server instance(s), other device and/or server instance(s), etc.) in a virtual topology, connectivity information between the network node instance(s), and/or other information about the virtual topology to be implemented.

At block 82, the processing circuitry may configure connectivity between the network node instances in the same virtual topology. As an example, the processing circuitry may perform at least some (e.g., all) of the operations described in connection with FIG. 3 at block 82. In particular, the processing circuitry may configure connectivity for a management network that communicatively couples the network node instances, e.g., such that a management server instance (or generally a management node instance) is reachable by each network device instance in the same virtual topology, by providing corresponding instructions and/or configuration data to respective host(s) 18.

At block 84, the processing circuitry may configure network device instances to boot up in a provisioning mode of operation. As an example, the processing circuitry may perform at least some (e.g., all) of the operations described in connection with FIG. 4 at block 84. In particular, the processing circuitry may configure the network device instances with an indication to enable a provisioning mode upon bootup by providing corresponding instructions (e.g., an instruction to enable the provisioning mode) and/or configuration data to respective host(s) 18 on which the network device instances are implemented.

At block 86, the processing circuitry may configure a device management server instance to provide a network address assignment service. As an example, the processing circuitry may perform at least some (e.g., all) of the operations described in connection with FIG. 5 at block 86. In particular, the processing circuitry may generate a network address assignment configuration file for the device management server instance. The processing circuitry may configure the device management server instance with an indication to enable a network address assignment service and with the generated configuration file by providing corresponding instructions (e.g., an instruction to enable the network address assignment service) and/or configuration data (e.g., the generated configuration file) to respective host(s) 18 on which the device management server instance is implemented.

At block 88, the processing circuitry may configure the device management server instance to onboard the network device instances as the network device instances are provisioned. As an example, the processing circuitry may perform at least some (e.g., all) of the operations described in connection with FIG. 6 at block 88. In particular, the processing circuitry may configure the device management server instance to register corresponding network device instances and store respective network device information for a device management platform provided by the device management server, based on determining that the network device instances are performing self-provisioning operations. The processing circuitry may configure the device management server in this manner by providing corresponding instructions and/or configuration data to respective host(s) 18 on which the device management instance is implemented. Thereafter, external equipment may access the onboarded or registered network device instances and information thereof using the device management platform.

Based on the operations described in connection with FIGS. 1-7, the provisioning and onboarding operation of network devices such as network devices 34 may be automated and simplified for a network administrator, among other advantages.

The methods and operations described above in connection with FIGS. 1-7 may be performed by the components of network device(s) and/or server(s) or other host equipment using software, firmware, and/or hardware (e.g., dedicated circuitry or hardware). Software code for performing these operations may be stored on non-transitory computer-readable storage media (e.g., tangible computer-readable storage media) stored on one or more of the components of the network device(s) and/or server(s) or other host equipment. The software code may sometimes be referred to as software, data, instructions, program instructions, or code. The non-transitory computer-readable storage media may include drives, non-volatile memory such as non-volatile random-access memory (NVRAM), removable flash drives or other removable media, other types of random-access memory, etc. Software stored on the non-transitory computer readable-storage media may be executed by processing circuitry of the network device(s) and/or server(s) or other host equipment.

The foregoing is merely illustrative and various modifications can be made to the described embodiments. The foregoing embodiments may be implemented individually or in any combination.

What is claimed is:

1. Virtual topology management equipment comprising:
memory circuitry; and
processing circuitry coupled to the memory circuitry and configured to:
receive a topology file for implementing a virtual topology;
provide an instruction to instantiate a device management server instance on a host based on the topology file; and
configure, based on the topology file, the device management server instance to provide a network address assignment service for one or more network device instances in the virtual topology.

2. The virtual topology management equipment defined in claim 1, wherein the processing circuitry is configured to:
provide an instruction to instantiate a given network device instance in the one or more network device instances based on the topology file; and
configure the given network device instance to boot up in a provisioning mode in which the given network device instance requests a network address for the given network device instance and performs device self-provisioning using the device management server instance.

3. The virtual topology management equipment defined in claim 2, wherein the processing circuitry is configured to:
configure the virtual topology to provide a management network with connectivity between the device management server instance and the given network device instance.

4. The virtual topology management equipment defined in claim 3, wherein the processing circuitry is configured to:
configure the device management server instance to onboard, based on the given network device instance performing the device self-provisioning using the device management server instance, the given network device instance by storing information of the given network device instance as onboarded network device information.

5. The virtual topology management equipment defined in claim 4, wherein the stored information of the given network device instance is accessible by an administrator device via the device management server instance.

6. The virtual topology management equipment defined in claim 2, wherein the topology file includes an indication to enable the provisioning mode for the given network device instance and wherein the given network device instance is configured based on the indication.

7. The virtual topology management equipment defined in claim 1, wherein the topology file includes an indication to enable the network address assignment service on the device management server instance and wherein the processing circuitry is configured to provide an instruction to initialize the network address assignment service on the device management server instance based on the indication.

8. The virtual topology management equipment defined in claim 7, wherein the processing circuitry is configured to generate a configuration file to include, for a given network device instance, an identifier of the given network device instance, a network address to be assigned to the given network device instance, and a bootstrap data identifier for providing the given network device instance with bootstrap data.

9. The virtual topology management equipment defined in claim 8, wherein the processing circuitry is configured to provide, to the device management server instance, the configuration file based on which the network address assignment service is provided on the device management server instance.

10. The virtual topology management equipment defined in claim 8, wherein the processing circuitry is configured to:
configure the device management server instance to provide the bootstrap data for the given network device instance, wherein the bootstrap data identifier in the configuration file identifies the bootstrap data on the device management server instance.

11. Virtual topology management equipment comprising:
memory circuitry; and
processing circuitry coupled to the memory circuitry and configured to:
receive topology information for implementing a virtual topology using host equipment, the topology information including an indication to enable a network address assignment service on a device management server instance;
provide an instruction to instantiate the device management server instance on a host based on the topology information;
generate configuration information for use by the network address assignment service based on the indication to enable the network address assignment service on the device management server instance; and
provide the generated configuration information for use by network address assignment service to the device management server instance.

12. The virtual topology management equipment defined in claim 11, wherein the configuration information identifies a network address for assignment to a given network device instance and wherein the network address for assignment is identified as part of definition information in the topology information for the given network device instance.

13. The virtual topology management equipment defined in claim 12, wherein the configuration information includes an identifier associated with the given network device instance.

14. The virtual topology management equipment defined in claim 13, wherein the identifier is a media access control (MAC) address associated with the given network device instance.

15. The virtual topology management equipment defined in claim 13, wherein the identifier associated with the given network device instance is absent from the received topology information and wherein the processing circuitry is configured to obtain the identifier associated with the given network device instance.

16. The virtual topology management equipment defined in claim 13, wherein the configuration information includes a bootstrap data identifier that identifies bootstrap data for provisioning the given network device instance.

17. Host equipment comprising:
memory circuitry; and
processing circuitry coupled to the memory circuitry and configured to:
instantiate a device management server instance based on an instruction from topology management equipment;
receive, from the topology management equipment, a configuration file for providing a network address assignment service and an indication to initialize the network address assignment service on the device management server instance; and
provide the network address assignment service on the management server instance based on the configuration file.

18. The host equipment defined in claim 17, wherein the processing circuitry is configured to:
receive, from a network device instance, a network address assignment request; and
transmit, by the network address assignment service and based on the configuration file, a network address assignment response to the network device instance that is responsive to the network address assignment request, wherein the network address assignment response includes a network address assigned to the network device instance and an identifier of bootstrap data for the network device instance.

19. The host equipment defined in claim 18, wherein the reception of network device assignment request and the transmission of the network address assignment response is part of a provisioning operation of the network device instance using the device management server instance, wherein the processing circuitry is configured to:
store information of the network device instance based on the device management server being used for the provisioning operation of the network device instance; and
provide at least some of the information of the network device instance to an administrator device.

20. The host equipment defined in claim 17, wherein the configuration file includes network address assignment information for a plurality of network device instances and wherein the device management server instance and the plurality of network device instances are implemented as part of a virtual topology managed by the topology management equipment.
